(19) United States
(12) Patent Application Publication
(10) Pub. No.: US 2005/0169318 A1
(43) Pub. Date: Aug. 4, 2005

(54) Microcomputer that does not cause destruction of peripherals

(75) Inventors: Hiroaki Minemura, Kawasaki (JP); Yuichi Shibayama, Kawasaki (JP); Yoshiyuki Kubo, Kawasaki (JP); Kazuhiro Yokoyama, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 10/854,636

(22) Filed: May 27, 2004

(30) Foreign Application Priority Data
Jan. 29, 2004 (JP) 2004-021655

(51) Int. Cl. H04J 3/06

(52) U.S. Cl. 370/503

(57) ABSTRACT

A microcomputer includes a clock monitor circuit which receives a clock signal and monitors a state of the clock signal, a communication interface configured to communicate with an exterior by operating according to a register value of a control register, a core circuit which operates based on the clock signal and controls an operation of the communication interface by setting a register value in the control register, and a register setting circuit which sets a predetermined register value in the control register in response to a glitch of the clock signal detected by the clock monitor circuit.

### CROSS-REFERENCE TO RELATED APPLICATIONS

The present application is based upon and claims the benefit of priority from the prior Japanese Patent Application No. 2004-021655 filed on Jan. 29, 2004, with the Japanese Patent Office, the entire contents of which are incorporated.

### BACKGROUND OF THE INVENTION

1. Field of the Invention

The present invention generally relates to microcomputers, and particularly relates to a microcomputer which operates based on a clock signal and is provided with a function to communicate with peripheral devices.

2. Description of the Related Art

Systems that need to perform complex control operations are often provided with a one-chip microcomputer, which is implemented as a single chip incorporating various functions. When such a one-chip microcomputer is built in a system for use in a car, for example, it is paramount that safety is not undermined with respect to the system. For safety consideration, an important issue is to prevent the microcomputer from malfunctioning.

A microcomputer with a built-in RC oscillator is an example of the microcomputers that are provided with an error-proof function. When a glitch such as the uncoupling of an external oscillator occurs, a clock monitor circuit monitoring clock conditions switches an operating clock to the oscillating clock of a built-in RC oscillation circuit. With this provision, the microcomputer can continue its normal operation.

The more consolidated the system control functions in a one-chip microcomputer, the greater the concern about the malfunction of a microcomputer resulting in a system-wide failure that involves peripheral devices. The microcomputer with a built-in RC oscillation circuit prevents the microcomputer itself from stopping its operation, but does not address the issue of a malfunction having a spreading effect on the peripheral devices.
[Patent Document 1] Japanese Patent Application Publication No. 7-6155

### SUMMARY OF THE INVENTION

It is a general object of the present invention to provide a microcomputer that substantially obviates one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a microcomputer particularly pointed out in the specification in such full, clear, concise, and exact terms as to enable a person having ordinary skill in the art to practice the invention.

To achieve these and other advantages in accordance with the purpose of the invention, the invention provides a microcomputer, including a clock monitor circuit which receives a clock signal and monitors a state of the clock signal, a communication interface configured to communicate with an exterior by operating according to a register value of a control register, a core circuit which operates based on the clock signal and controls an operation of the communication interface by setting a register value in the control register, and a register setting circuit which sets a predetermined register value in the control register in response to a glitch of the clock signal detected by the clock monitor circuit.

According to another aspect of the invention, the microcomputer as described above further includes an access control circuit which makes the core circuit unable to write in the control register in response to the glitch of the clock signal detected by the clock monitor circuit.

According to another aspect of the invention, the register setting circuit sets the predetermined register value in the control register through hardware control without use of software control.

In the microcomputer described above, the control register of the communication interface is set to the predetermined register value, thereby making sure that the communication interface does not destroy the circuit of a peripheral device.

Further, the microcomputer as described above is configured such that the register value of the control register is not changed due to the malfunction of the core circuit. When a clock glitch occurs due to the uncoupling of an external oscillator or the like, or even when the core circuit malfunctions due to a clock glitch, it is ensured that the peripheral device is not physically destroyed.

Moreover, the microcomputer as described above is configured such that the setting of a register value in the control register is implemented only by use of hardware control (hardwired control) without the use of software. Even if the core circuit gets out of control, therefore, the control register is reliably set to the predetermined register value at high speed without a undue time lag.

### BRIEF DESCRIPTION OF THE DRAWINGS

Other objects and further features of the present invention will be apparent from the following detailed description when read in conjunction with the accompanying drawings, in which:

FIG. 1 is a block diagram showing an example of the construction of a microcomputer according to the invention;

FIG. 2 is a circuit diagram showing an example of the more detailed construction of the microcomputer according to the invention; and

FIG. 3 is a block diagram showing a schematic construction of a clock monitor circuit.

### DESCRIPTION OF THE PREFERRED EMBODIMENTS

Microcomputers communicate various data with peripheral devices. When a glitch such as the defect or uncoupling of an external oscillator occurs, the peripheral devices may possibly be destroyed due to the anomaly of communication systems of the microcomputer. The control register of a communications-system macro such as the UART (Universal Asynchronous Receiver Transmitter) may store erroneous data due to the malfunctioning of a microcomputer, for example. In such a case, both the peripheral devices and the microcomputer may transmit data, resulting in the collision of transmitted data. When this happens, not only the peripheral devices malfunction, but also an excess electric current may flow, causing the circuitry destruction of the peripheral devices.

In the microcomputer with a built-in RC oscillator as described above, an oscillating clock is switched to that of the built-in RC oscillator to prevent a malfunction caused by a glitch such as the defect or uncoupling of an external oscillator, but an effect on the peripheral devices cannot be eliminated. This is because the switching of an operating clock to that of the built-in RC oscillator is not completed instantly, but requires a finite length of time before its completion. Moreover, a noise generated by the uncoupling of the oscillator may enter a clock signal line, which upsets the timing of programs inside the microcomputer, resulting in the operation of the microcomputer getting out of control. Because of this, not only the peripheral devices malfunction due to erroneous data stored in the control resister of a communications-system macro, but also an excess electric current may flow, causing the circuitry destruction of the peripheral devices.

Conventionally, software-based measures have often been taken to prevent such malfunction. Since the occurrence of a glitch is monitored at some intervals, however, a noticeable time period passes from the occurrence of an oscillator glitch to the start of an action for preventing malfunction. During this time period, the circuitry of the peripheral devices may be destroyed due to the same causes as described above.

Accordingly, there is a need for a microcomputer which is provided with a function to prevent a peripheral device in communication from being physically destroyed when an oscillator glitch occurs.

In the following, embodiments of the present invention will be described with reference to the accompanying drawings.

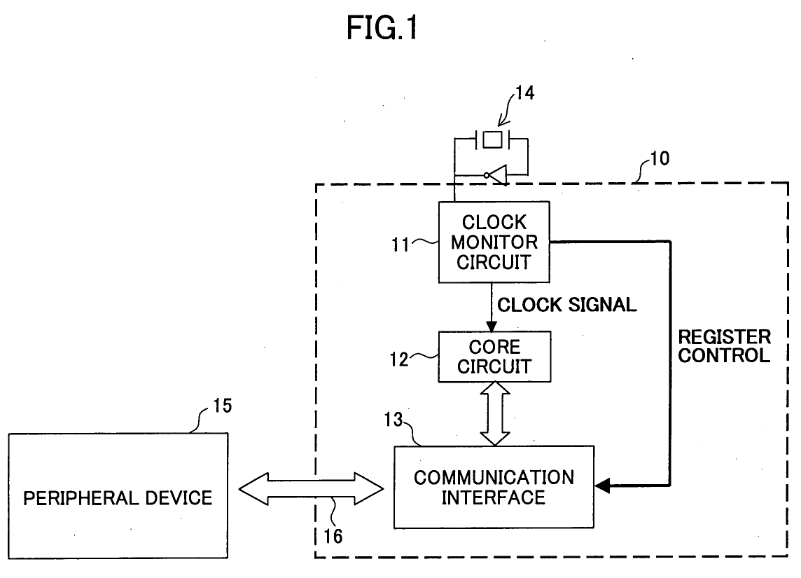

FIG. 1 is a block diagram showing an example of the construction of a microcomputer according to the invention.

The microcomputer 10 of FIG. 1 includes a clock monitor circuit 11, a core circuit 12, and a communication interface 13. The microcomputer 10 is connected to an external oscillator 14, and operates based on a clock signal generated by the external oscillator 14. Moreover, the microcomputer 10 is connected to a peripheral device 15 and communicates data with the peripheral device 15 through the communication interface 13.

In the microcomputer 10, the clock monitor circuit 11 receives a clock signal from the external oscillator 14, and monitors the clock signal as to whether its conditions are normal. The clock signal may be supplied to the core circuit 12 through the clock monitor circuit 11. Alternatively, the clock signal may be directly supplied to the core circuit 12 without passing through the clock monitor circuit 11 while it is also supplied to the clock monitor circuit 11. The core circuit 12 may be a CPU, for example, and performs various control operations with respect to the microcomputer 10. Further, the core circuit 12 carries out various system control operations by controlling data communication with the peripheral device 15 through the communication interface 13.

When a glitch such as clock severance occurs with respect to the clock signal supplied from the external oscillator 14 due to the uncoupling of the external oscillator 14, for example, the clock monitor circuit 11 directly controls the communication interface 13 so as to set the communication interface 13 in a predetermined state. The predetermined state may be defined as a state in which the communication interface 13 does not physically destroy the peripheral device 15. For example, a data-communication line 16 connecting between the communication interface 13 and the peripheral device 15 may be separated from the communication interface 13. To this end, the data-communication line 16 may be set in a floating state on the side of the communication interface 13. Alternatively, the data-communication line 16 may be set to a LOW potential by the communication interface 13 if the setting of the data-communication line 16 to the LOW potential is a default state during the period of no communication.

Moreover, the clock monitor circuit 11 performs such control as to prohibit the core circuit 12 from accessing the communication interface 13, thereby avoiding a change in the state of the communication interface 13 due to the operation of the core circuit 12. With the control operations as described above, the communication interface 13 is set in such a state as not to destroy the circuitry of the peripheral device 15 (i.e., not to cause physical destruction), and, also, it is ensured that the state of the communication interface 13 is not changed by the malfunction or the like of the core circuit 12. When a clock glitch occurs due to the uncoupling of the external oscillator 14 or the like, or even when the core circuit 12 malfunctions due to a clock glitch, it is ensured that the peripheral device 15 is not destroyed physically.

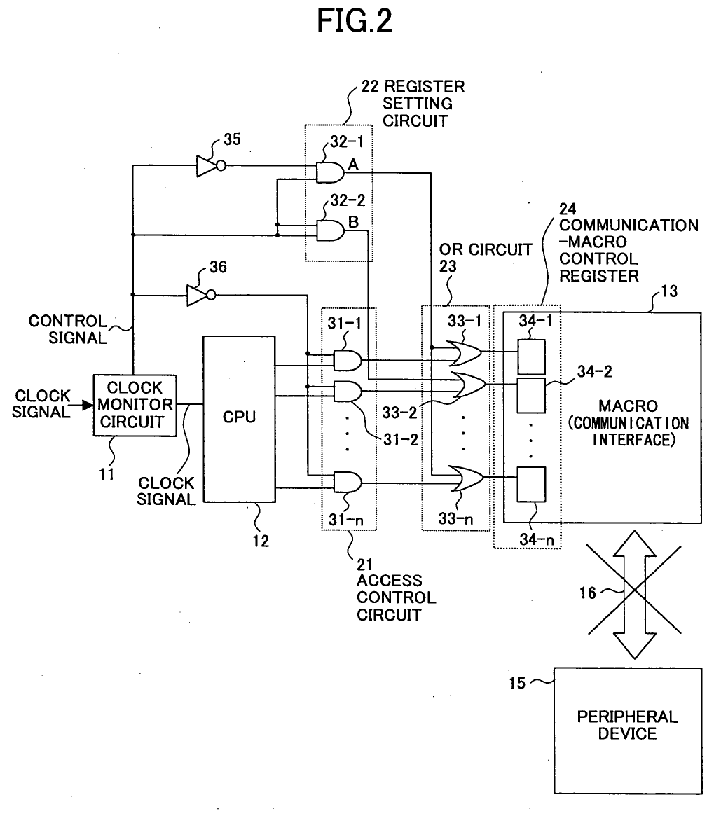

FIG. 2 is a circuit diagram showing an example of the construction of the microcomputer according to the invention.

The microcomputer of FIG. 2 includes the clock monitor circuit 11, a CPU 12 that is the core circuit, the communication interface 13, an access control circuit 21, a register setting circuit 22, an OR circuit 23, and inverters 35 and 36 for carrying control signals. The communication interface 13 communicates data with the peripheral device 15 through the data-communication line 16. The communication interface 13 is provided with a communication-macro control register 24, and data communication is controlled according to the register settings of the communication-macro control register 24.

The clock monitor circuit 11 receives a clock signal from the external oscillator 14, and supplies the clock signal to the CPU 12. Moreover, the clock monitor circuit 11 checks whether the state of the clock signal is normal, and outputs a control signal responsive to the checked state. In the example of the construction of FIG. 2, the control signal is LOW when the state of the clock signal is normal, and is HIGH when the state of the clock signal is abnormal. If a failure such as the uncoupling of the external oscillator 14 occurs, the clock monitor circuit 11 detects the event so as to output a HIGH control signal.

The access control circuit 21 controls access from the CPU 12 to the communication interface 13, and includes AND gates 31-1 through 31-n. The control signal output from the clock monitor circuit 11 is supplied to one input of each of the AND gates 31-1 through 31-n through the inverter 36. Further, a signal from the CPU 12 is supplied to the other input of each of the AND gates 31-1 through 31-n. The outputs of the AND gates 31-1 through 31-n are written in the communication-macro control register 24 through the OR circuit 23. With this provision, if the clock signal is normal, the register data output from the CPU 12 passes through the access control circuit 21 for storage in the communication-macro control register 24. If the clock signal is abnormal, the register data is blocked by the access control circuit 21 so as not to be written in the communication-macro control register 24.

The register setting circuit 22 serves to generate register data that is to be stored in the communication-macro control register 24 at the time of clock signal anomaly. This register data is set to such a value that the communication interface 13 does not destroy the circuitry of the peripheral device 15. The register data may be such a value that the data-communication line 16 is separated from the communication interface 13. For this purpose, a value that sets the data-communication line 16 in a floating state on the side of the communication interface 13 may be used. Alternatively, the data-communication line 16 may be set to a LOW potential by the communication interface 13 if the setting of the data-communication line 16 to the LOW potential is a default state during the period of no communication.

In the example shown in FIG. 2, the register setting circuit 22 includes AND gates 32-1 and 32-2. If the control signal output from the clock monitor circuit 11 is LOW, the outputs of the AND gates 32-1 and 32-2 are LOW. The register setting circuit 22 thus does not output a register setting value. When the control signal output from the clock monitor circuit 11 is changed to HIGH, the AND gates 32-1 and 32-2 output respective outputs A and B that are set to “0” and “1”, respectively. Accordingly, a predetermined register value is set in the registers 34-1 through 34-n of the communication-macro control register 24. What value is stored in the registers 34-1 through 34-n of the communication-macro control register 24 is controlled by selecting either one of the outputs of the AND gates 32-1 and 32-2 for coupling to each of the registers 34-1 through 34-n.

The OR circuit 23 serves to supply the register value from the CPU 12 and the register value from the register setting circuit 22 to the communication-macro control register 24, and includes OR gates 33-1 through 33-n. As described above, a register value is supplied from the CPU 12 through the access control circuit 21 when the clock signal state is normal. In this case, this register value is stored in the communication-macro control register 24. When the clock signal state is abnormal, on the other hand, signals for setting a register value are supplied from the register setting circuit 22. In this case, a predetermined register value is stored in the communication-macro control register 24 by using these signals.

With the control operations as described above, the communication-macro control register 24 of the communication interface 13 is set to such a register value as not to destroy the circuitry of the peripheral device 15 (i.e., not to cause physical destruction), and, also, it is ensured that the register value of the communication-macro control register 24 is not changed by the malfunction or the like of the core circuit 12. When a clock glitch occurs due to the uncoupling of the external oscillator or the like, or even when the CPU 12 malfunctions due to a clock glitch, it is ensured that the peripheral device 15 is not physically destroyed.

Moreover, the setting of a register value in the communication-macro control register 24 based on signals supplied from the access control circuit 21 is implemented by use of hardware control (hardwired control) without the use of software. Even if the CPU 12 gets out of control, therefore, the communication-macro control register 24 is reliably set to a predetermined register value at high speed without a undue time lag.

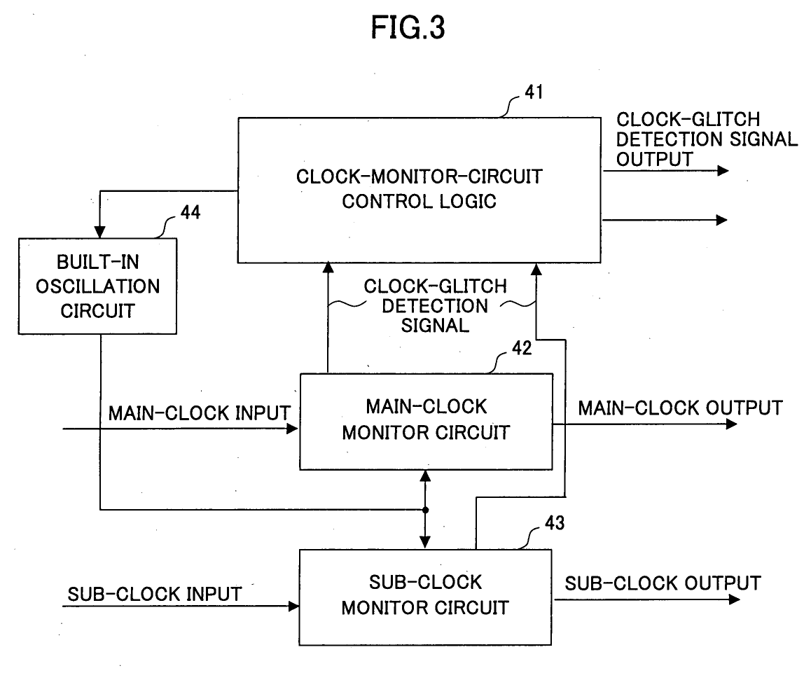

FIG. 3 is a block diagram showing a schematic construction of the clock monitor circuit 11. In FIG. 3, there are two clock-signal systems, one for a main-clock signal and the other for a sub-clock signal.

The clock monitor circuit 11 of FIG. 3 includes a clock-monitor-circuit control logic 41, a main-clock monitor circuit 42, a sub-clock monitor circuit 43, and a built-in oscillation circuit 44.

The oscillating signal of the built-in oscillation circuit 44 is supplied to both the main-clock monitor circuit 42 and the sub-clock monitor circuit 43. The main-clock monitor circuit 42 receives a main-clock signal from an external oscillator, and supplies the main-clock signal to a core circuit. The sub-clock monitor circuit 43 receives a sub-clock signal from an external oscillator, and supplies the sub-clock signal to the core circuit. The main-clock monitor circuit 42 and the sub-clock monitor circuit 43 monitor the main-clock signal and the sub-clock signal, respectively, based on the oscillating signal of the built-in oscillation circuit 44. If a clock glitch is detected, the main-clock monitor circuit 42 and the sub-clock monitor circuit 43 assert respective clock-glitch detection signals to the clock-monitor-circuit control logic 41. Here, the clock glitch refers to the severance of a clock signal, for example, and may also include a case in which the clock signal becomes irregular.

The clock-monitor-circuit control logic 41 responds to the assertion of the clock-glitch detection signals supplied from the main-clock monitor circuit 42 and/or the sub-clock monitor circuit 43 so as to output clock-glitch detection signals (i.e., the control signals) indicative of the anomaly of the main-clock signal and the sub-clock signal, respectively. With these controls signals, the communication-macro control register 24 of the communication interface 13 is set to a predetermined value, and the core circuit (CPU) 12 is prohibited from accessing the communication-macro control register 24. This is the same as described above.

Further, the present invention is not limited to these embodiments, but various variations and modifications may be made without departing from the scope of the present invention.

1. A microcomputer, comprising:
a clock monitor circuit which receives a clock signal and monitors a state of the clock signal;
a communication interface configured to communicate with an exterior by operating according to a register value of a control register;
a core circuit which operates based on the clock signal and controls an operation of said communication interface by setting a register value in the control register; and
a register setting circuit which sets a predetermined register value in the control register in response to a glitch of the clock signal detected by said clock monitor circuit.

2. The microcomputer as claimed in claim 1, further comprising an access control circuit which makes said core circuit unable to write in the control register in response to the glitch of the clock signal detected by said clock monitor circuit.

3. The microcomputer as claimed in claim 1, wherein said clock monitor circuit asserts a control signal in response to the detection of the glitch of the clock signal, and said register setting circuit sets the predetermined register value in the control register without an aid of said core circuit in response to the assertion of the control signal.

4. The microcomputer as claimed in claim 3, wherein said register setting circuit sets the predetermined register value in the control register through hardware control without use of software control.

5. The microcomputer as claimed in claim 1, wherein the glitch of the clock signal is a severance of the clock signal.

6. The microcomputer as claimed in claim 1, wherein the predetermined register value is such a register value that said communication interface does not destroy a device provided at an opposite end of communication.

7. The microcomputer as claimed in claim 1, wherein the predetermined register value is such a register value that a signal line connecting between said communication interface and a device provided at an opposite end of communication is separated from said communication interface.

8. The microcomputer as claimed in claim 1, wherein the predetermined register value is such a register value that an output from said communication interface to a device provided at an opposite end of communication is set in a floating state.

9. The microcomputer as claimed in claim 1, wherein the predetermined register value is such a register value that an output from said communication interface to a device provided at an opposite end of communication is set to a potential indicative of a state of no communication.
